(19) United States
(12) Patent Application Publication
(10) Pub. No.: US 2015/0151994 A1
(43) Pub. Date: Jun. 4, 2015

(54) SINGLE-TANK NUTRIENT REMOVAL SYSTEM USING IMMOBILIZED BIOMASS

(71) Applicant: Laleh Yerushalmi, Ottawa (CA)

(72) Inventor: Laleh Yerushalmi, Ottawa (CA)

(73) Assignee: BioCAST Systems Inc., Montreal (CA)

(21) Appl. No.: 14/096,230

(22) Filed: Dec. 4, 2013

(51) Int. Cl. C02F 3/02

(52) U.S. Cl. CPC C02F 3/02; C02F 2103/06

(57) ABSTRACT

A method and system are provided for treating water, such as wastewater, landfill leachate, or contaminated groundwater. A single tank is used. A structure with a unique design within the tank promotes growth of immobilized biomass. A recycle stream transports some of the fluid output from near the top of the tank back to the bottom of the tank, the rest of the fluid output leaving the water treatment system as effluent. Oxygenation means within the tank cause fluid to flow upwards, and this together with the recycle stream causes fluid to circulate through the immobilized biomass. The oxygenation means result in the formation of an aerobic zone, and the location and/or aeration flow rate of the oxygenation means result in an oxygen-depleted zone. Different processes occur in the aerobic and oxygen-depleted zones, removing a variety of contaminants. The use of a recycle stream and of immobilized biomass results in efficient water treatment, even though a single tank is used, and the water treatment system can have a low footprint and cost.

### FIELD OF INVENTION

This invention relates to waste water treatment, and more particularly to a system for removing contaminants from wastewater using microbial biomass.

### BACKGROUND

The treatment of wastewater from municipal, industrial, or agricultural activities requires removal of organic and inorganic contaminants before discharge of the wastewater into receiving waters. Contaminated groundwater or landfill leachate can also be treated in order to remove contaminants. Organic contaminants, or carbonaceous compounds, may contain sources of BOD and COD as well as hazardous chemicals such as aromatic hydrocarbons, including benzene, toluene, ethylbenzene, xylenes, phenols, cresols, polycyclic aromatic hydrocarbons (PAHs), and halogenated (e.g., chlorinated) hydrocarbons, such as tetrachloroethylene, trichloroethylene, 1,1,1-trichloroethane and similar xenobiotic compounds. Inorganic contaminants include nitrogenous and phosphorus compounds, which are among the most undesirable inorganic contaminants of wastewater and contaminated groundwater.

Biological treatment processes use a variety of microorganisms for efficient biodegradation of contaminants in wastewater, contaminated groundwater, and landfill leachate. In general, the efficiency of biological treatment of contaminated water increases with increased concentration of biomass and increased mean cell residence time (MCRT), alternatively known as solid retention time (SRT). MCRT and SRT correspond to the residence time of microorganisms in the treatment system. High biomass concentration and high MCRT contribute to a high volumetric removal rate and a high specific removal rate of contaminants. A high MCRT enhances microbial adaptation to the variations of influent wastewater characteristics, including the concentration of contaminants, the incoming flow rate, and possible toxic shocks.

One system using biomass to treat wastewater is described in U.S. Pat. No. 7,820,047, incorporated by reference herein. Two interlinked reactors are used, together having four independent zones with different environmental conditions. Influent enters the first reactor, where aeration through air diffusers causes liquid to circulate throughout the first reactor. An aerobic zone is located in the upper central portion of the first reactor. The aerobic zone contains both fixed-film and suspended microorganisms. The fixed-film biomass grows on a support medium located in a portion of the aerobic zone. The suspended microorganisms are located in the open portion of the aerobic zone. Liquid circulates down through a microaerophilic zone in the first reactor to an anoxic zone. The air diffusers are located below the aerobic zone and above the anoxic zone, provide aeration which causes the liquid to flow upward in the aerobic zone and downwards in microaerophilic zone on a continuous basis. Aeration through the air diffusers also supplies oxygen to the liquid. Microbial biomass continues to grow and accumulate inside the circulation liquid, leading to increased biomass concentration and high MCRT.

The second reactor is designed for sludge digestion and solid-liquid separation. Effluent from the first reactor is directed to the second reactor for additional clarification, while the sludge generated in the first reactor is transferred from the anoxic zone to the anaerobic zone located at the bottom of the second reactor. A recycle stream between the anaerobic zone of the second reactor and the aerobic zone of the first reactor returns a mixture of solids and liquid that contains volatile fatty acids produced from digestion of the sludge and phosphorous accumulating organisms to the first reactor. The phosphorus accumulating organisms are used in the first reactor in phosphorus removal, and the volatile fatty acids are used as substrate for microorganisms that are used for phosphorous removal and nitrogen removal.

While the design of the two-tank system described in U.S. Pat. No. 7,820,047 is effective at treating wastewater, contaminated groundwater, and landfill leachate, treatment could be improved still further in a system which reduced even more the production of and need to digest sludge. Such a system would also ideally have a less complicated design, which would reduce both the complexity and the footprint of the water treatment.

### SUMMARY

According to one aspect, a water treatment system is provided. The water treatment system has a tank having an outlet near the top of the tank through which substantially treated water can leave the system as effluent. The tank also has an inlet, an aerobic zone, and an oxygen-depleted zone. The water treatment system also has oxygenation means within the tank, and an interior structure within the tank, the interior structure comprising at least two concentric structures. The water treatment system also has a recycle stream that returns a portion of water leaving the tank via the outlet to near the bottom of the tank. In one embodiment, the exterior side of each concentric structure contains rods or plates or a combination of rods and plates, and an upper and a lower base of the concentric structures are connected by rods or plates or a combination of rods and plates.

According to another aspect, a method of treating water is provided. Water is fed into a tank. The water is circulated upwards through an oxygen-depleted zone in the tank by means of oxygenation means which cause an upward flow of the water. The water is circulated upwards through an aerobic zone in the tank, the aerobic zone containing an interior structure on which immobilized biomass is located, the first interior structure comprising at least two concentric structures. Water is passed out of the tank. A portion of the water passing out of the tank is recirculated back to the bottom of the tank using a recycle stream. In one embodiment, the exterior side of each concentric structure contains rods or plates or a combination of rods and plates, and an upper and a lower base of the concentric structures are connected by rods or plates or a combination of rods and plates.

Embodiments of the invention allow efficient removal of contaminants with use of a single tank. The use of an internal structure within the tank allows microbial immobilization, providing higher biomass concentrations than usually found in treatment systems using suspended biomass form. In addition, the mean cell residence time (MCRT) in the present systems is considerably higher than that achievable in suspended-growth systems. These attributes contribute to high volumetric removal rate and high specific removal rate of contaminants. The high MCRT enhances microbial adaptation to the variations of influent wastewater and contaminated groundwater characteristics, including the concentration of contaminants and the incoming flow rate, as well as possible toxic shocks. The increased concentration of immobilized biomass and high MCRT prevent excessive growth of biomass and considerably reduce the generation of biosolids or sludge by the treatment system. The use of a single tank reduces the footprint, cost, and complexity of the wastewater treatment system. The use of an internal structure which promotes immobilized biomass results in considerably less sludge compared to the conventional treatment systems that use suspended-growth biomass. The use of a recycle stream ensures that water to be treated circulates through the tank, and organic and inorganic contaminants are still effectively removed from water to be treated. The unique design of the interior structure of the treatment tank that serves for immobilization of microbial biomass and formation of microbial biofilm encourages growth of immobilized biomass and increase in thickness of microbial biofilm. This design ensures continuous flow of fluid inside the treatment tank during long-term operations without the occurrence of any clogging, which is commonly experienced in other treatment systems that use immobilized biomass.

### BRIEF DESCRIPTION OF THE DRAWINGS

The features and advantages of embodiments of the invention will become more apparent from the following detailed description of the preferred embodiment(s) with reference to the attached figures, wherein:

FIG. 1 shows a single-tank wastewater treatment system according to one embodiment of the invention;

FIG. 2 shows a single-tank wastewater treatment system according to another embodiment of the invention; and

FIG. 3 shows a single-tank wastewater treatment system according to yet another embodiment of the invention.

It is noted that in the attached figures, like features bear similar labels.

### DETAILED DESCRIPTION OF THE PREFERRED EMBODIMENTS

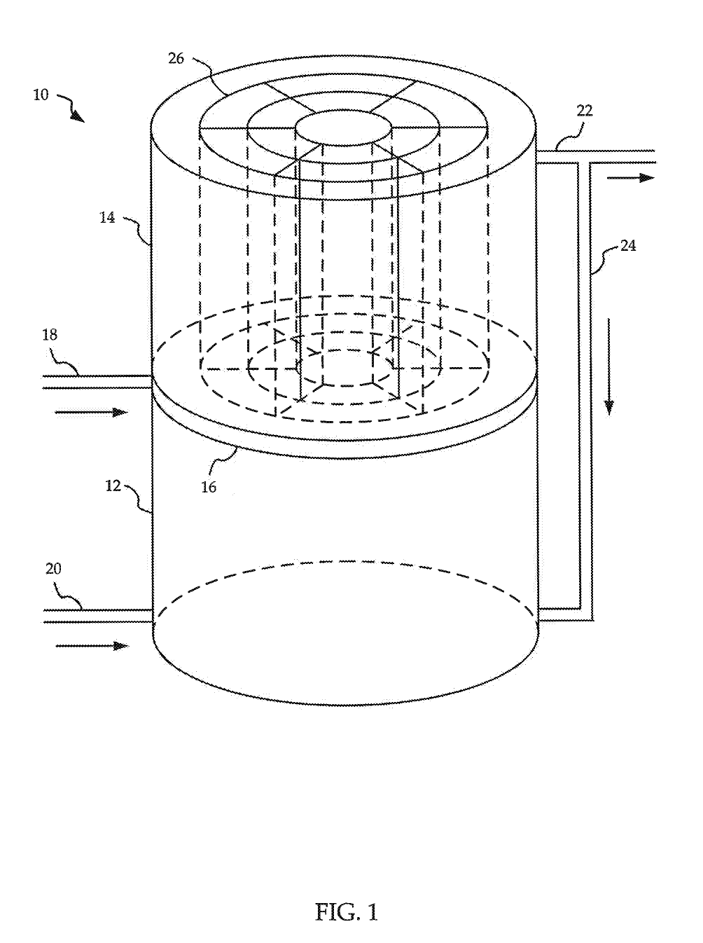

Referring to FIG. 1, a single-tank wastewater treatment system according to one embodiment of the invention is shown. The system comprises a single tank 10 having a lower section 12 and an upper section 14. The lower section 12 and the upper section 14 are distinguished by oxygenation means 16 supplied by an oxygenation line 18. Some examples of oxygenation means are a blower, an air compressor, a jet aeration device, or a sparger. By reason of the gas emitted by the oxygenation means 16 rising in the tank 10, the upper section 14 is an aerobic zone in which aerobic processes can take place. The lower section 12 is an oxygen-depleted zone in which anaerobic processes take place. The oxygen-depleted zone may contain microaerophilic, anoxic, and/or anaerobic conditions.

Influent enters the tank 10 via an inlet 20. The influent may comprise wastewater, landfill leachate, contaminated groundwater, or any other water to be treated. Fluid leaves the tank 10 via an outlet 22 as substantially treated water. Part of the fluid leaving via the outlet 22 leaves the wastewater treatment system as effluent. The effluent is treated water. Part of the fluid leaving via the outlet 22 returns to the tank 10 via a recycle stream 24 entering the tank 10 near the bottom of the tank 10. The recycle stream 24 delivers a fraction of the fluid from the upper section 14 to the lower section 12. The recycle stream 24 travels in a pipe having a smaller diameter than that of the tank 10. Diameters of pipes commonly used in wastewater treatment operations are in the range of few inches, depending on the operating flow rate. The pipe carrying the recycle stream 24 is outside the tank 10 and does not constitute a separate zone, and is solely used for rapid transfer of liquid from one section of the tank 10 to another section. As a result of the recycle stream 24 and the oxygenation means 16, fluid circulates continuously upwards from the lower section 12 to the upper section 14 then back to the lower section 12 via the recycle stream 24, although some of the fluid leaves the wastewater treatment system as effluent.

The upper section 14 of the tank 10 comprises a special interior structure 26 comprising two or more concentric structures. The concentric structures promote the attachment and growth of microbial biomass, thus producing immobilized microorganisms. Although the concentric structures are shown in FIG. 1 as being circular, more generally the concentric structures can be cylindrical or rectangular or have any other geometrical shape. Accordingly, the cross sectional area of the said structures can be circular, rectangular, triangular, pentagonal or have any other geometrical shape. The exterior side of the structures contains rods or plates or their combination having openings between some or all of the said rods or said plates or their combination. The upper and lower bases of the structures are connected by rods or plates or their combination having openings between some or all of the said rods or said plates or their combination. For the sake of clarity, not all connections between the upper and lower bases of the structures are shown in FIG. 1.

The concentric structures are made out of metal, plastic, or any durable, non-toxic and non-biodegradable material that can hold its shape and durability during the operation of the water treatment system, which can last from a number of days to several years. The surface of the material of the structures can be smooth, or rough, or scratchy, or coarse to facilitate the attachment and immobilization of microbial biomass. The concentric structures may also be completely or partially wrapped with a non-toxic and non-biodegradable wrapping material that can support microbial attachment and growth. These types of wrapping material are known to those skilled in the art. Some examples of wrapping material are fabrics, geotextiles, polymeric material such as membranes, and plastic strings. During the wastewater treatment operation, the wrapping material may be in the form of strips or strings to cover all or parts of the concentric structures as required by the characteristics of the target wastewater and the demand for the growth of microorganisms, without interfering with the flow of wastewater through the concentric structures. The design of the concentric structures facilitates continuous flow of fluid through the tank 10 and supports microbial attachment and immobilization and formation of biofilm, while preventing clogging even during long-term operation of the treatment system.

Broadly, in operation water is fed into the tank 10, for example into the lower section 12 of the tank 10. The water is circulated upwards through the oxygen-depleted zone in the tank 10 by means of oxygenation means which cause an upward flow of the water. The water is circulated upwards through the aerobic zone in the tank, the aerobic zone containing the interior structure on which immobilized biomass is located, the interior structure comprising at least two concentric structures. Water is passed out of the tank. A portion of the water passing out of the tank is re-circulated back to the bottom of the tank using the recycle stream. In one embodiment, the exterior side of each concentric structure contains rods or plates or a combination of rods and plates, and an upper and a lower base of the concentric structures are connected by rods or plates or a combination of rods and plates.

The fluid communication between the lower section 12 and the upper section 14 ensures the continuous circulation of at least a part of wastewater between the aerobic and anaerobic environmental conditions. The flow of wastewater through the concentric structures that exist in the upper section 14 ensures the attachment, growth and formation of immobilized biomass, alternatively known as fixed-film or biofilm or attached-growth microbial biomass, at high concentrations. It is known to those skilled in the art that the concentration of biomass in immobilized form is usually higher than biomass concentrations in suspended form which are commonly used in treatment systems such as activated sludge. In addition, it is also known to the persons skilled in the art of wastewater treatment that the mean cell residence time (MCRT) or solid retention time (SRT) in immobilized systems are considerably higher than those achievable in suspended-growth systems. MCRT or SRT correspond to the residence time of microorganisms in the treatment system. These attributes, i.e. high biomass concentration and high MCRT, contribute to high volumetric removal rate and high specific removal rate of contaminants. The high MCRT enhances microbial adaptation to the variations of influent wastewater and contaminated groundwater characteristics, including the concentration of contaminants and the incoming flow rate, as well as possible toxic shocks. In addition, the increased concentration of immobilized biomass and high MCRT prevent excessive growth of biomass and considerably reduce the generation of biosolids or sludge by the treatment system. Hence, the wastewater treatment system produces considerably less sludge compared to the conventional treatment systems that use suspended-growth biomass.

The tank 10 removes carbonaceous compounds by biological degradation mostly through the action of immobilized aerobic microorganisms in the upper section 14. Nitrogen and phosphorus are partly consumed by microorganisms as essential nutrients to support microbial growth during assimilatory processes, while excess amounts of nitrogenous compounds is removed during dissimilatory microbial nitrogen metabolism where they are transformed to molecular nitrogen and released into the atmosphere. The remaining phosphorus may be removed by the well-known enhanced biological phosphorus removal (EBPR) or “luxury phosphorus uptake” process where special groups of microorganisms accumulate phosphorus and store it in their intercellular space as poly-phosphorus compounds, thus removing it from the system during waste sludge disposal. Some nitrogen and phosphorus are also removed by the formation of chemical compounds that precipitate to the bottom of the tank 10.

A part of the dissimilatory biological nitrogen removal process that involves ammonia oxidation, or the nitrification process, takes place in the upper section 14, in which aerobic processes can occur. The complete removal of nitrogen takes place by the denitrification process in the lower section 12 in which anaerobic processes can occur. During this process, the nitrates produced during the nitrification process in the upper aerobic zone 14 are transferred to the lower oxygen-depleted zone 12 by the recycle fluid stream 24, and they are converted to nitrogen gas for complete removal of nitrogen from the wastewater. It is possible that the circulation of fluid between the aerobic zone 14 and the oxygen-depleted zone 12 promotes the removal of nitrogen by a different biological process that involves autotrophic microorganisms. In this process, nitrogen removal takes place by the combined nitritation and anammox process whereby ammonium is partly oxidized to nitrite by autotrophic ammonium oxidizing bacteria and then the complete oxidation of ammonium takes place under anoxic or anaerobic conditions by the anammox bacteria with nitrite serving as the electron acceptor, producing nitrogen gas as the product.

The continuous circulation of a part of wastewater between the upper aerobic zone 14 and the lower oxygen-depleted zone 12 that contains anaerobic conditions promotes the growth and proliferation of phosphorus accumulating organisms (PAOs) that contribute to the removal of phosphorus by the luxury phosphorus removal process. A part of the organic material in the wastewater is converted in the lower oxygen-depleted zone 12 to short-chain volatile fatty acids (VFAs) by anaerobic fermentative bacteria through anaerobic biological processes. The produced VFAs provide an easily biodegradable carbon source for the denitrification process and for the PAOs involved in the luxury phosphorus removal process. The microorganisms, including phosphorus accumulating microorganisms or PAOs that carry out the removal of phosphorus by the luxury phosphorus removal process, travel to the upper aerobic zone 14 by the upward flow of wastewater in the tank 10. The treated effluent leaves the treatment system from the upper section 14 of the tank 10.

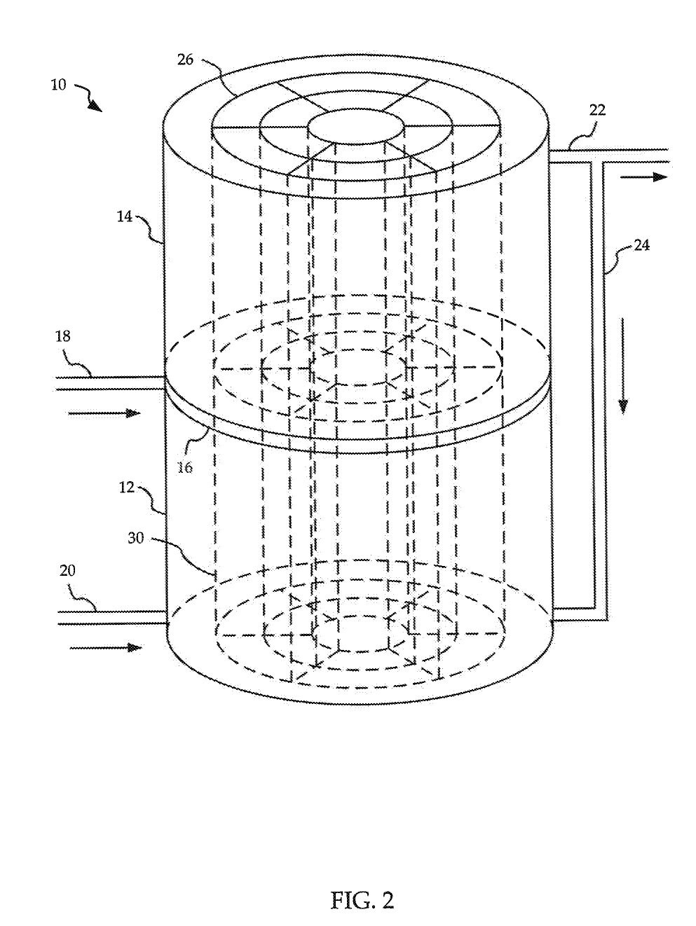

In the embodiment described above, the lower section 12 is left empty (other than fluid to be treated). Alternatively, the lower section 12 may have some immobile objects to serve as microbial support, such as a similar interior structure as that 26 located in the upper section 14. This latter embodiment is illustrated in FIG. 2, in which the lower section 12 has an interior structure 30 similar to that in the upper section 14. The interior structure located in the lower zone 12 may even be an extension of the interior structure 26 located in the upper section 14. The presence of microbial support, whether in the form of some immobile objects or a similar interior structure as that of the upper section 14, in the lower section 12 ensures the attachment, growth and formation of immobilized biomass, alternatively known as fixed-film or biofilm or attached-growth microbial biomass, at high concentrations in the lower section 12.

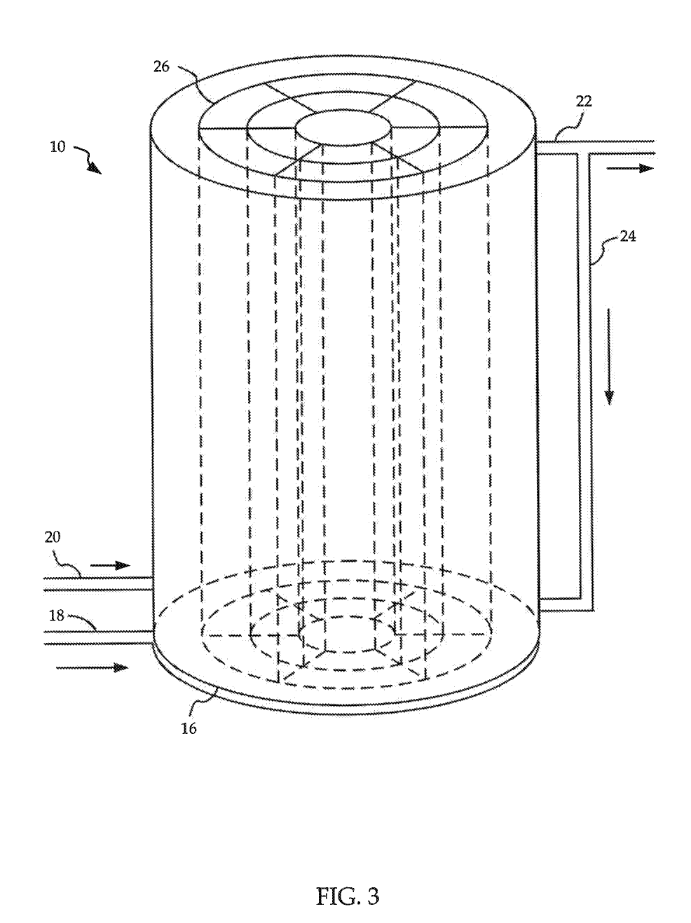

Referring to FIG. 3, a single-tank wastewater treatment system according to another embodiment of the invention is shown. In this embodiment the oxygenation means 16 is located at the bottom of the tank 10. There is no structural distinction between the aerobic zone and the oxygen-depleted zone. Instead, an oxygen-depleted zone having anoxic or microaerophilic conditions is formed near the top of the tank 10 to serve in the removal of nitrogen, if required. The oxygen-depleted zone having anoxic or microaerophilic conditions is formed by the control of the oxygenation rate so as to ensure high dissolved oxygen concentrations near the oxygenation means 16, and low or zero dissolved oxygen concentrations near the top of the tank 10. This embodiment is particularly useful when nutrient (nitrogen and phosphorus) removal is not required and the removal of carbonaceous compounds from the wastewater is the only purpose of wastewater treatment. This embodiment is also useful when nutrient (nitrogen and phosphorous) removal is required but the concentrations of nitrogen and phosphorus in the wastewater are low and they can be removed partly by assimilatory processes during the growth of microbial biomass and partly by dissimilatory biological processes owing to the presence of the anoxic and microaerophilic conditions near the top of the tank 10. This embodiment is particularly suitable for the treatment of municipal wastewaters that traditionally have low nutrient contents.

The different embodiments of the treatment system that enable the placement of the aeration device at various locations inside the tank support the establishment of different biochemical processes, owing to the formation of a multiplicity of environmental conditions, including aerobic, microaerophilic, anoxic and anaerobic. The different biochemical processes are needed for the remove of carbonaceous, nitrogenous and phosphorus compounds. These features increase the operation flexibility and capacity of the treatment system to treat wastewaters with different characteristics, including municipal wastewaters as well as high organic-load and nutrient-rich wastewaters of industrial or agricultural origin.

In the embodiments described above, the inlet 20 is located near the bottom of the tank 10. Alternatively, the inlet 20 can provide influent near the top of the tank 10, or indeed at any height within the tank 10.

The embodiments presented are exemplary only and persons skilled in the art would appreciate that variations to the embodiments described above may be made without departing from the spirit of the invention. The scope of the invention is solely defined by the appended claims.

I/We claim:

1. A water treatment system, comprising:
a tank having an outlet near the top of the tank through which substantially treated water can leave the system as effluent, an inlet, an aerobic zone, and an oxygen-depleted zone;
oxygenation means within the tank;
a first interior structure within the tank, the first interior structure comprising at least two concentric structures;
a recycle stream returning a portion of water leaving the tank via the outlet to near the bottom of the tank.

2. The water treatment system of claim 1 wherein the oxygenation means is located part way up the tank, the aerobic zone is located above the oxygenation means, and the oxygen-depleted zone is located below the oxygenation means.

3. The water treatment system of claim 2 wherein the first interior structure is entirely within the aerobic zone.

4. The water treatment system of claim 2 further comprising a second interior structure entirely within the oxygen-depleted zone.

5. The water treatment system of claim 4 wherein the second interior structure has a structure similar to that of the first interior structure.

6. The water treatment system of claim 1 wherein the oxygenation means is located near the bottom of the tank, and wherein the aerobic zone is located below the oxygen-depleted zone.

7. The water treatment system of claim 6 wherein the first interior structure occupies substantially the whole tank.

8. The water treatment system of claim 1 wherein an exterior side of each concentric structure contains rods or plates or a combination of rods and plates, and wherein an upper and a lower base of the concentric structures are connected by rods or plates or a combination of rods and plates.

9. The water treatment system of claim 8 wherein the concentric structures are completely or partially wrapped with a wrapping material that can support microbial attachment and growth.

10. The water treatment system of claim 9 wherein the wrapping material is in the form of strips or strings.

11. The water treatment system of claim 1 wherein biomass is located on the first interior structure.

12. A method of treating water, comprising:
feeding water into a tank;
circulating the water upwards through an oxygen-depleted zone in the tank by means of oxygenation means which cause an upward flow of the water;
circulating the water upwards through an aerobic zone in the tank, the aerobic zone containing a first interior structure on which immobilized biomass is located, the first interior structure comprising at least two concentric structures;
passing water out of the tank;
re-circulating a portion of the water passing out of the tank back to the bottom of the tank using a recycle stream.

13. The method of claim 12 wherein the oxygenation means is located part way up the tank, the aerobic zone is located above the oxygenation means, and the oxygen-depleted zone is located below the oxygenation means.

14. The method of claim 13 wherein the first interior structure is entirely within the aerobic zone.

15. The method of claim 13 further comprising a second interior structure entirely within the oxygen-depleted zone.

16. The method of claim 15 wherein the second interior structure has a structure similar to that of the first interior structure.

17. The method of claim 12 wherein the oxygenation means is located near the bottom of the tank, and wherein the aerobic zone is located below the oxygen-depleted zone.

18. The method of claim 17 wherein the first interior structure occupies substantially the whole tank.

19. The method of claim 12 wherein an exterior side of each concentric structure contains rods or plates or a combination of rods and plates, and wherein an upper and a lower base of the concentric structures are connected by rods or plates or a combination of rods and plates.

20. The method of claim 19 wherein the concentric structures are completely or partially wrapped with a wrapping material that can support microbial attachment and growth.

21. The method of claim 20 wherein the wrapping material is in the form of strips or strings.
